(19) United States
(12) Patent Application Publication
(10) Pub. No.: US 2016/0263531 A1
(43) Pub. Date: Sep. 15, 2016

(54) PLASMA-TREATED POLYMERIC MEMBRANES

(71) Applicants: Ihab Nizar ODEH, Sugar Land, TX (US); Lei SHAO, Thuwal (SA); SABIC Global Technologies B.V., 1077 XV Amsterdam (NL)

(72) Inventors: Ihab N. Odeh, Sugar Land, TX (US); Lei Shao, Thuwal (SA)

(21) Appl. No.: 15/031,625

(22) PCT Filed: Dec. 15, 2014
(86) PCT No.: PCT/US2014/070306

§ 371 Date: Apr. 22, 2016

Related U.S. Application Data
(60) Provisional application No. 61/916,584, filed on Dec. 16, 2013.

(51) Int. Cl. B01D 67/00; B01D 69/08; B01D 69/04; B01D 69/06; B01D 53/22; B01D 71/52

(52) U.S. Cl. CPC B01D 67/009; B01D 53/228; B01D 71/52; B01D 69/04; B01D 69/06; B01D 69/08; B01D 2325/02

(57) ABSTRACT

Disclosed are polymeric blend membranes, and methods for their use, they have been plasma-treated. The polymeric membranes include a polymeric blend of polymer of intrinsic microporosity (PIM) and a second polymer.

### CROSS REFERENCE TO RELATED APPLICATIONS

This application claims benefit to U.S. Provisional Patent Application No. 61/916,584 titled “PLASMA-TREATED POLYMERIC MEMBRANES”, filed Dec. 16, 2013. The contents of the referenced patent application are incorporated into the present application by reference.

### BACKGROUND OF THE INVENTION

A. Field of the Invention

The present invention relates to plasma-treated polymeric membranes having a polymeric blend of a polymer of intrinsic microporosity (PIM) and a second polymer such as a polyetherimide (PEI) polymer. The membranes have improved permeability and selectivity parameters for gas, vapor, and liquid separation applications. In particular embodiments, the plasma-treated membranes are particularly useful for nitrogen/methane, hydrogen/methane and hydrogen/nitrogen separation applications.

B. Description of Related Art

A membrane is a structure that has the ability to separate one or more materials from a liquid, vapor or gas. It acts like a selective barrier by allowing some material to pass through (i.e., the permeate or permeate stream) while preventing others from passing through (i.e., the retentate or retentate stream). This separation property has wide applicability in both the laboratory and industrial settings in instances where it is desired to separate materials from one another (e.g., removal of nitrogen or oxygen from air, separation of hydrogen from gases like nitrogen and methane, recovery of hydrogen from product streams of ammonia plants, recovery of hydrogen in oil refinery processes, separation of methane from the other components of biogas, enrichment of air by oxygen for medical or metallurgical purposes, enrichment of ullage or headspace by nitrogen in inerting systems designed to prevent fuel tank explosions, removal of water vapor from natural gas and other gases, removal of carbon dioxide from natural gas, removal of H₂S from natural gas, removal of volatile organic liquids (VOL) from air of exhaust streams, desiccation or dehumidification of air, etc.).

Examples of membranes include polymeric membranes such as those made from polymers, liquid membranes (e.g., emulsion liquid membranes, immobilized (supported) liquid membranes, molten salts, etc.), and ceramic membranes made from inorganic materials such as alumina, titanium dioxide, zirconia oxides, glassy materials, etc.

For gas separation applications, the membrane of choice is typically a polymeric membrane. One of the issues facing polymeric membranes, however, is their well-known trade-off between permeability and selectivity as illustrated by Robeson's upper bound curves (see L. M. Robeson, Correlation of separation factor versus permeability for polymeric membranes, J. Membr. Sci., 62 (1991) 165). In particular, there is an upper bound for selectivity of, for example, one gas over another, such that the selectivity decreases linearly with an increase in membrane permeability. Both high permeability and high selectivity are desirable attributes, however. The higher permeability equates to a decrease in the size of the membrane area required to treat a given volume of gas. This leads to a decrease in the costs of the membrane units. As for higher selectivity, it can result in a process that produces a more pure gas product.

A majority of the polymeric membranes that are currently used in the industry fail to perform above a given Robeson's upper bound trade-off curve. That is, a majority of such membranes fail to surpass the permeability-selectivity trade-off limitations, thereby making them less efficient and more costly to use. As a result, additional processing steps may be required to obtain the level of gas separation or purity level desired for a given gas.

### SUMMARY OF THE INVENTION

A solution to the disadvantages of the currently available membranes has now been discovered. The solution is based on a surprising discovery that the selectivity of a polymeric membrane having a polymeric blend of at least a polymer of intrinsic microporosity (PIM) and a second polymer can be dramatically improved by subjecting said membrane to a plasma-treatment. For instance, membranes of the present invention exhibit a selectivity of nitrogen to methane that exceeds the Robeson upper bound trade-off curve. Without wishing to be bound by theory, it is believed that the plasma treatment modifies the first few hundred angstroms from the topmost layer of the membrane surface such that the membranes exhibit an improved selectivity of particular materials (e.g., N₂ from CH₄ or H₂ from CH₄ or H₂ from N₂) when compared to similar membranes that have not been subjected to plasma treatment.

In one particular instance of the present invention, there is disclosed a polymeric membrane comprising a polymeric blend having a polymer of intrinsic microporosity (PIM) and a second polymer, wherein the polymeric membrane has been plasma-treated. The PIM polymer can be PIM-1. The second polymer can be selected from a different PIM polymer (e.g., polymeric blend of two different PIM polymers), a polyetherimide (PEI) polymer, a polyimide (PI) polymer, or a polyetherimide-siloxane (PEI-Si) polymer. In particular aspects, the first polymer is a PIM (e.g., PIM-1) and the second polymer is a PEI polymer (e.g., Ultem®, Extem®, or derivatives thereof). The polymers can be homogenously blended throughout the membrane. In addition to the first and second polymers, the membrane matrix can include at least a third, fourth, fifth, etc. polymer. Alternatively, the membranes may comprise a PIM polymer without a second polymer (e.g., non-polymeric blend). The blend can include at least one, two, three, or all four of said class of polymers. Further, the blend can be from a single class or genus of polymers (e.g., PIM polymer) such that there are at least two different types of PIM polymers in the blend (e.g., PIM-1 and PIM-7 or PIM and PIM-Pi) or from a (PEI) polymer such that there at least two different types of PEI polymers in the blend (e.g., Ultem® and Extem® or Ultem® and Ultem® 1010 commercially available from SABIC Innovative Plastics Holding BV), or from a PI polymer such that there are at least two different types of PI polymers in the blend, or a PEI-Si polymer such that there are two different types of PEI-Si polymers in the blend. In particular instances, the blend can include polymers from different classes (e.g., a PIM polymer with a PEI polymer, a PIM polymer with a PI polymer, a PIM polymer with a PEI-Si polymer. PEI polymer with a PI polymer, a PEI polymer with a PEI-Si polymer, or a PI polymer with a PEI-Si polymer). In one particular embodiment, blend can be a (PIM) as PIM-1 with a PEI polymer (e.g., Ultem® and Extem® or Ultem® and Ultem® 1010) and the polymeric membrane can be designed such that it is capable of separating a first gas from a second gas, wherein both gases are comprised within a mixture. In a preferred aspect, the polymeric membrane can include a PIM polymer and a PEI polymer and can be capable of separating nitrogen from methane, hydrogen from methane, or hydrogen from nitrogen. Such polymeric membranes can have a selectivity of nitrogen to methane that exceeds the Robeson's upper bound trade-off curve at a temperature of 25° C. and a feed pressure of 2 atm. The polymeric membrane (e.g. a portion of the surface or the entire surface of the membrane) can be plasma-treated with a plasma comprising a reactive species for 30 seconds to 30 minutes, 30 second to 10 minutes, 1 to 5 minutes, or 2 to 4 minutes. The temperature of the plasma treatment can be 15° C. to 80° C. or about 50° C. The plasma gas can include O₂, N₂, NH₃, CF₄, CCl₄, C₂F₄, C₂F₆, C₃F₆, C₄F₈, Cl₂, H₂, He, Ar, CO, CO₂, CH₄, C₂H₆, C₃H₈, or any mixture thereof. In particular embodiments, the reactive gas can include O₂ and CF₄ at a ratio of up to 1:2. In some aspects, the amount of the polymers in the membrane can be such that said membranes include 5 to 95% by weight of the PIM polymer and from 95 to 5% by weight of the second polymer or any range therein (e.g., the membranes can include at least 5, 10, 15, 20, 25, 30, 35, 40, 45, 50, 55, 60, 65, 70, 75, 80, 85, or 95% by weight of the first or second polymers). In more particular aspects, the amounts can range such that said membranes include from 80 to 95% w/w of the PIM polymer (e.g., PIM-1) and from 5 to 20% w/w of the second polymer (e.g., PEI polymer). The membranes can be flat sheet membranes, spiral membranes, tubular membranes, or hollow fiber membranes. In some instances, the membranes can have a uniform density, can be symmetric membranes, asymmetric membranes, composite membranes, or single layer membranes. The membranes can also include an additive (e.g., a covalent organic framework (COF) additive, a metal-organic framework (MOF) additive, a carbon nanotube (CNT) additive, fumed silica (FS), titanium dioxide (TiO₂) or graphene).

Also disclosed are processes of using the polymeric membranes disclosed throughout this specification. In one instance, the process can be used to separate two materials, gases, liquids, compounds, etc. from one another. Such a process can include contacting a mixture or composition having the materials to be separated on a first side of the membrane, such that at least a first material is retained on the first side in the form of a retentate and at least a second gas is permeated through the membrane to a second side in the form of a permeate. The feed pressure of the mixture to the membrane or the pressure at which the mixture is fed to the membrane can be 1, 2, 3, 4, 5, 6, 7, 8, 9, 10, 11, 12, 13, 14, 15, 16, 17, 18, 19 and 20 atm or more or can range from 1 to 20 atm, 2 to 15 atm, or from 2 to 10 atm. Further the temperature during the separation step can be 20, 25, 30, 35, 40, 45, 50, 55, 60, or 65° C. or more or can range from 20 to 65° C. or from 25 to 65° C. or from 20 to 30° C. The process can further include removing or isolating either or both of the retentate and/or the permeate from the composition or membrane. The retentate and/or the permeate can be subjected to further processing steps such as a further purification step (e.g., column chromatography, additional membrane separation steps, etc.). In particular instances, the process can be directed to removing at least one of N₂, H₂, CH₄, CO₂, C₂H₄, C₂H₆, C₃H₆, and/or C₃H₈ from a mixture. In preferred aspects, the membranes can be used to separate N₂, from a mixture of gases that includes at least N₂ and CH₄. In other preferred aspects, the membranes can be used to separate H₂ from a mixture of gases that includes at least H₂ and CH₄ or can be used to separate H₂ from a mixture of gases that includes at least H₂ and N₂. Examples of processes that the membranes of the present invention can be used in include gas separation (GS) processes, vapour permeation (VP) processes, pervaporation (PV) processes, membrane distillation (MD) processes, membrane contactors (MC) processes, and carrier mediated processes, sorbent PSA (pressure swing absorption), etc. Further, it is contemplated that at least 2, 3, 4, 5, or more of the same or different membranes of the present invention can be used in series with one another to further purify or isolate a targeted liquid, vapour, or gas material. Similarly, the membranes of the present invention can be used in series with other currently known membranes to purify or isolate a targeted material.

In another aspect, there is disclosed a method of making a polymeric membrane of the present invention such as by treating at least a portion of a surface of a polymeric membrane that has a polymeric blend of at least a polymer of intrinsic microporosity (PIM) and a second polymer, wherein said treatment comprises subjecting said surface to a plasma comprising a reactive species. As discussed above and throughout this specification, the second polymer can be a second PIM polymer, a polyetherimide (PEI) polymer, a polyimide (PI) polymer, or a polyetherimide-siloxane (PEI-Si) polymer. In particular aspects, the plasma used in the plasma treatment can be generated by a glow discharge, corona discharge, Arc discharge, Townsend discharge, dielectric barrier discharge, hollow cathode discharge, radio-frequency (RF) discharge, microwave discharge, or electron beams. In particular aspects, the plasma is generated by a RF discharge, where a RF power of 10 W to 700 W, 50 W to 700 W, 300 W to 700 W, or greater than 50 W is applied to a plasma gas to produce said reactive species. The surface of the polymeric membrane can be plasma-treated for 30 seconds to 30 minutes, 30 second to 10 minutes, 1 to 5 minutes, or 2 to 4 minutes. The plasma treatment can be performed at a temperature ranging from 15° C. to 80° C. or about 50° C. The plasma treatment can be performed at a pressure of 0.1 Torr to 0.5 Torr. The plasma gas can be provided at a flow rate of from 0.01 to 100 cm³/min. In particular aspects, the plasma gas can include O₂, N₂, NH₃, CF₄, CCl₄, C₂F₄, C₂F₆, C₃F₆, C₄F₈, Cl₂, H₂, He, Ar, CO, CO₂, CH₄, C₂H₆, C₃H₈, or any mixture thereof. In preferred aspects, the reactive gas can include O₂ and CF₄, and the ratio of said gases can be up to 1:2. In instances where the reactive gas is a mixture of O₂ and CF₄, the O₂ can be provided at a flow rate of 0 to 40 cm³/min and the CF₄ can be provided at a flow rate of 30 to 100 cm³/min. This plasma-treatment can result in the gas separation performance of the plasma-treated polymeric membrane being enhanced when compared with a similar polymeric membrane that has not been subjected to said plasma treatment. The method can further include making the polymeric membranes by obtaining a mixture comprising at least the aforementioned PIM polymer and the second polymer, depositing the mixture onto a substrate and drying the mixture to form a membrane. The formed membrane can then be plasma-treated. The mixture can be a solution such that the first and second polymers are partially or fully solubilized within the solution or the mixture can be a dispersion such that the first and second polymers are dispersed in said mixture. The resulting membranes can be such that the polymers are homogenously blended throughout the membrane. Drying of the mixture can be performed, for example, by vacuum drying or heat drying or both.

Also disclosed is a gas separation device comprising any one of the polymeric membranes of the present invention. The gas separation device can include an inlet configured to accept feed material, a first outlet configured to expel a retentate, and a second outlet configured to expel a permeate. The device can be configured to be pressurized so as to push feed material through the inlet, retentate through the first outlet, and permeate through the second outlet. The device can be configured to house and utilize flat sheet membranes, spiral membranes, tubular membranes, or hollow fiber membranes of the present invention.

“Inhibiting” or “reducing” or any variation of these terms, when used in the claims or the specification includes any measurable decrease or complete inhibition to achieve a desired result.

“Effective” or “treating” or “preventing” or any variation of these terms, when used in the claims or specification, means adequate to accomplish a desired, expected, or intended result.

The term “about” or “approximately” are defined as being close to as understood by one of ordinary skill in the art, and in one non-limiting embodiment the terms are defined to be within 10%, preferably within 5%, more preferably within 1%, and most preferably within 0.5%.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The methods, ingredients, components, compositions, etc. of the present invention can “comprise,” “consist essentially of,” or “consist of” particular method steps, ingredients, components, compositions, etc. disclosed throughout the specification. With respect to the transitional phase “consisting essentially of,” in one non-limiting aspect, a basic and novel characteristic of the membranes of the present invention are their permeability and selectivity parameters.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

FIG. 1: Nuclear Magnetic Resonance (NMR) spectrum of PIM-1.

FIG. 2: Cross-section of masking method and lower cell flange.

FIG. 3: Flow scheme of the permeability apparatus.

FIG. 4: Gas separation performance for N₂/CH₄ of various membranes of the present invention.

FIG. 5: Gas separation performance for H₂/CH₄ of various membranes of the present invention.

FIG. 6: Gas separation performance for H₂/N₂ of various membranes of the present invention.

FIG. 7: Gas separation performance for H₂/CO₂ of various membranes of the present invention.

FIG. 8: Gas separation performance for CO₂/CH₄ of various membranes of the present invention.

FIG. 9: Gas separation performance for C₂H₄/C₂H₆ of various membranes of the present invention.

FIG. 10: Gas separation performance for C₃H₆/C₃H₈ of various membranes of the present invention.

### DETAILED DESCRIPTION OF THE INVENTION

Current polymeric membrane materials do not have sufficient permeability/selectivity properties. This leads to inefficiencies in separating techniques and increased costs associated with such techniques.

It has now been discovered that plasma-treated polymeric membranes having a polymeric blend of particular polymers have improved permeability and selectivity parameters that are currently lacking in today's available membranes. These discovered membranes can be used across a wide range of processes such as gas separation (GS) processes, vapour permeation (VP) processes, pervaporation (PV) processes, membrane distillation (MD) processes, membrane contactors (MC) processes, and carrier mediated processes. In particular instances, such treated membranes of the present invention have been shown to exhibit an improved selectivity of nitrogen from methane or hydrogen from methane or hydrogen from nitrogen when compared to similar membranes that have not been plasma-treated.

These and other non-limiting aspects of the present invention are discussed in the following subsections.

### A. Polymers

Non-limiting examples of polymers that can be used in the context of the present invention include polymers of intrinsic microporosity (PIMs), polyetherimide (PEI) polymers, polyetherimide-siloxane (PEI-Si) polymers, and polyimide (PI) polymers. As noted above, the compositions and membranes can include a blend of any one of these polymers (including blends of a single class of polymers and blends of different classes of polymers).

1. Polymers of Intrinsic Microporosity

PIMs are typically characterized as having repeat units of dibenzodioxane-based ladder-type structures combined with sites of contortion, which may be those having spiro-centers or severe steric hindrance. The structures of PIMs prevent dense chain packing, causing considerably large accessible surface areas and high gas permeability. The structure of PIM-1, which was used in the Examples, is provided below:

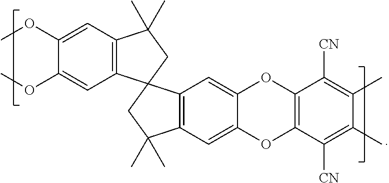

The molecular weight of said polymers can be varied as desired by increasing or decreasing the length of said polymers. PIM-1 can be synthesized as follows:

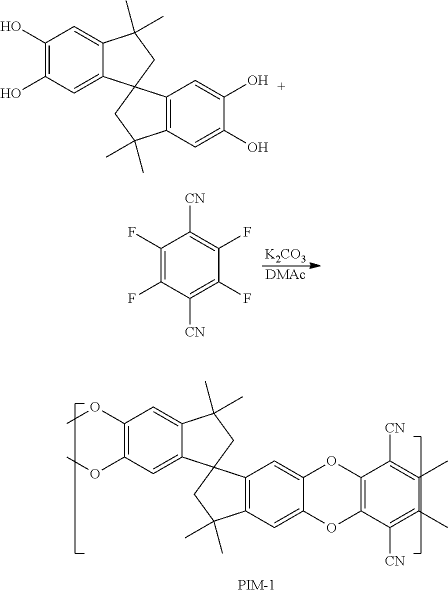

Additional PIMs that can be used in the context of the present invention have the following repeating units:

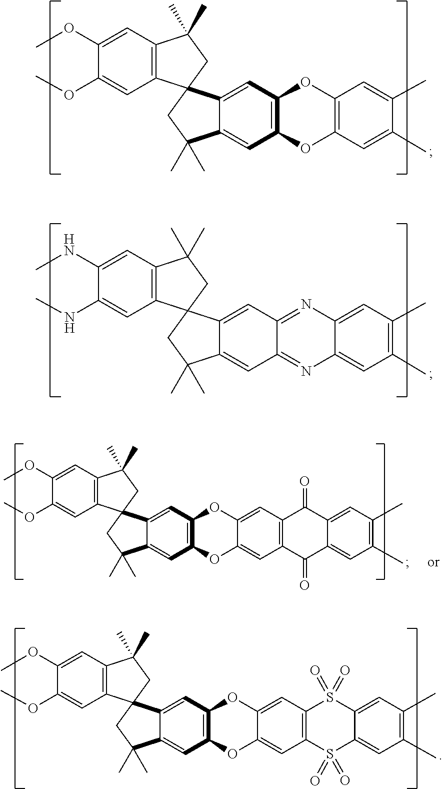

In some instances, the PIM polymers can be prepared using the following reaction scheme:

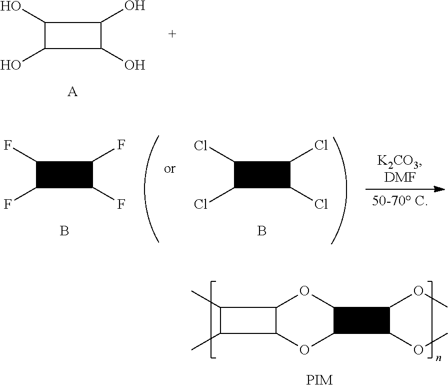

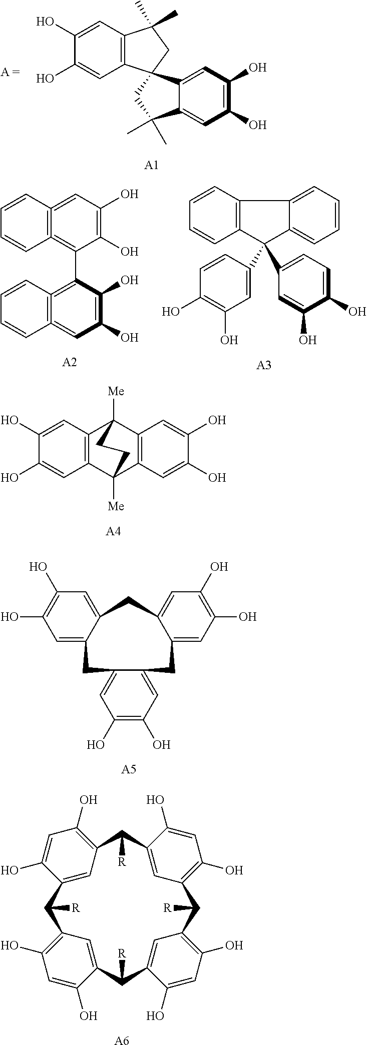

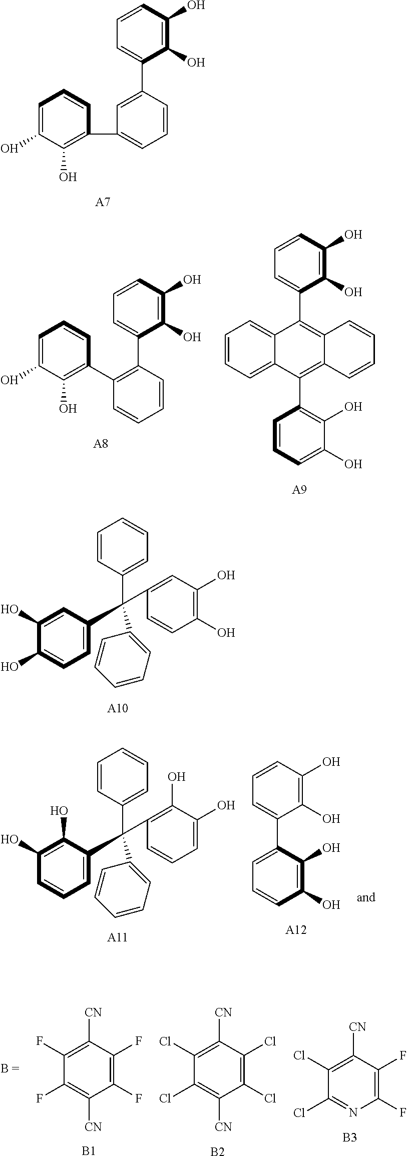

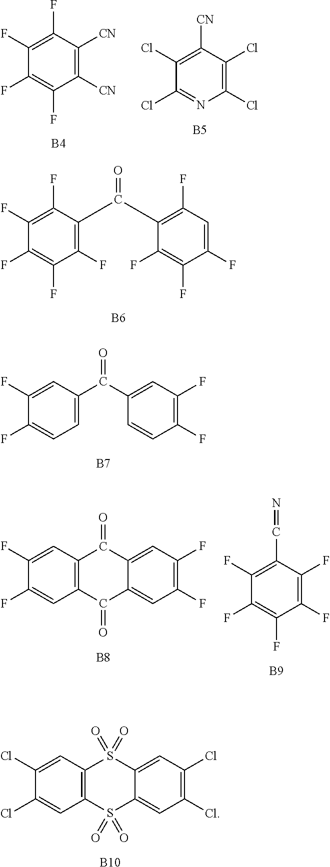

The above structures can further be substituted as desired.

An additional set of PIM polymers that can be used with the blended polymeric membranes of the present invention include the PIM-PI set of polymers disclosed in Ghanem et. al., High-Performance Membranes from Polyimides with Intrinsic Microporosity, Adv. Mater. 2008, 20, 2766-2771, which is incorporated by reference. The structures of these PIM-PI polymers are:

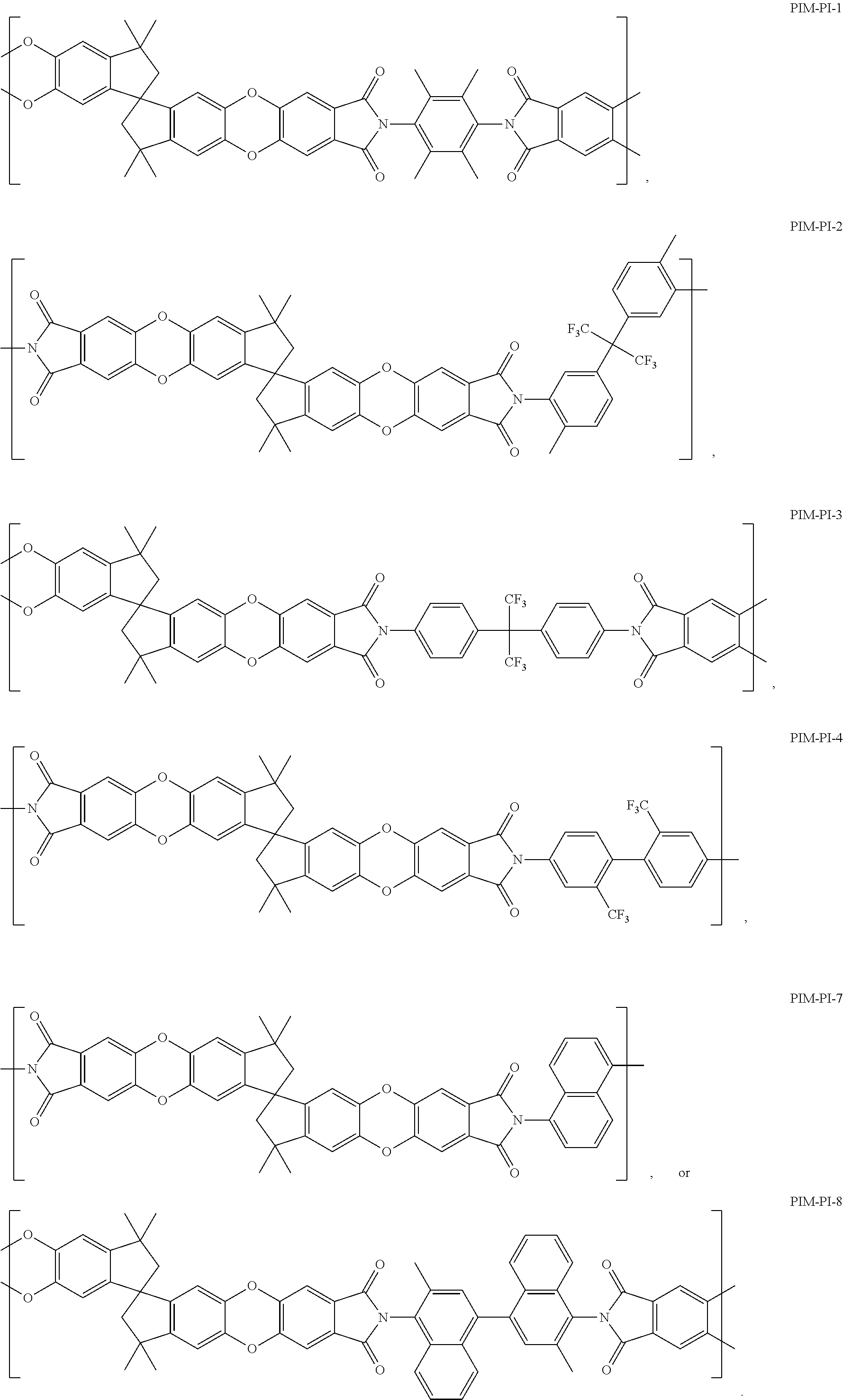

Additional PIMs and examples of how to make and use such PIMs are provided in U.S. Pat. No. 7,758,751 and U.S. Publication 2012/0264589, both of which are incorporated by reference.

2. Polyetherimide and Polyetherimide-Siloxane Polymers

Polyetherimide polymers that can be used in the context of the present invention generally conform to the following monomeric repeating structure:

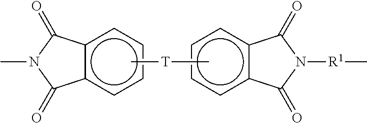

where T and R¹ can be varied to create a wide range of usable PEI polymers. R¹ can include substituted or unsubstituted divalent organic groups such as: (a) aromatic hydrocarbon groups having 6 to 24 carbon atoms and halogenated derivatives thereof; (b) straight or branched chain alkylene groups having 2 to 20 carbon atoms; (c) cycloalkylene groups having 3 to 24 carbon atoms, or (d) divalent groups of formula (2) defined below. T can be —O— or a group of the formula —O—Z—O— wherein the divalent bonds of the —O— or the —O—Z—O— group are in the 3,3′, 3,4′, 4,3′, or the 4,4′ positions. Z can include substituted or unsubstituted divalent organic groups such as: (a) aromatic hydrocarbon groups having about 6 to about 20 carbon atoms and halogenated derivatives thereof; (b) straight or branched chain alkylene groups having about 2 to about 20 carbon atoms; (c) cycloalkylene groups having about 3 to about 20 carbon atoms, or (d) divalent groups of the general formula (2);

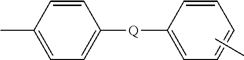

wherein Q can be a divalent moiety selected from the group consisting of —O—, —S—, —C(O)—, —SO₂—, —SO—, —C_{y}H_{2y}— (y being an integer from 1 to 8), and fluorinated derivatives thereof, including perfluoroalkylene groups. Z may comprise exemplary divalent groups of formula (3)

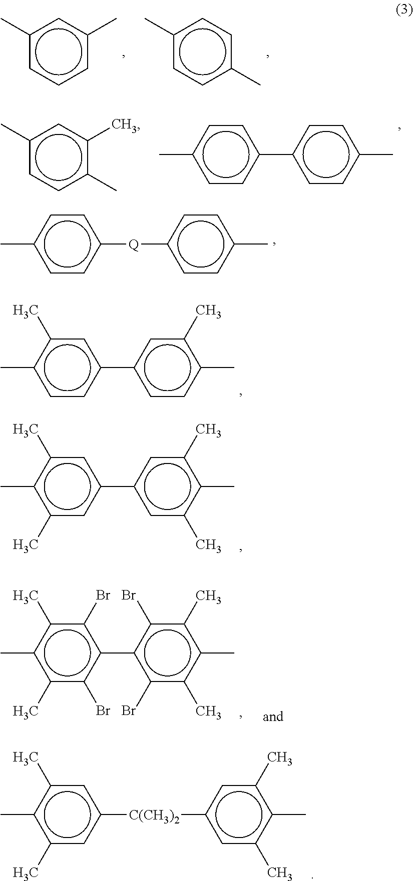

In particular instances, R¹ can be as defined in U.S. Pat. No. 8,034,857, which is incorporated into the present application by reference.

Non-limiting examples of specific PEIs that can be used (and that were used in the Examples) include those commercially available from SABIC Innovative Plastics Holding BV (e.g., Ultem® and Extem®). All various grades of Extem®) and Ultem® are contemplated as being useful in the context of the present invention (e.g., Extem® (VH 1003), Extem® (XH1005), and Extem® (XH1015)).

Polyetherimide siloxane (PEI-Si) polymers can be also used in the context of the present invention. Examples of polyetherimide siloxane polymers are described in U.S. Pat. No. 5,095,060, which is incorporated by reference. A non-limiting example of a specific PEI-Si that can be used include those commercially available from SABIC Innovative Plastics Holding BV (e.g., Siltem®). All various grades of Siltem® are contemplated as being useful in the context of the present invention (e.g., Siltem® (1700) and Siltem® (1500)).

3. Polyimide Polymers

Polyimide (PI) polymers are polymers of imide monomers. The general monomeric structure of an imide is:

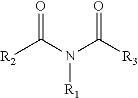

Polymers of imides generally take one of two forms: heterocyclic and linear forms. The structures of each are:

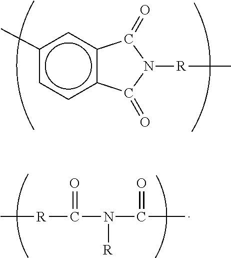

where R can be varied to create a wide range of usable PI polymers. A non-limiting example of a specific PI (i.e., 6FDA-Durene) that can be used is described in the following reaction scheme:

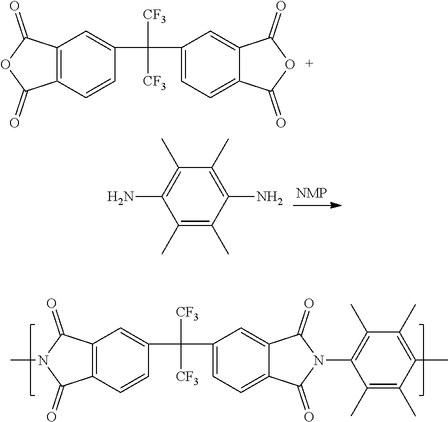

Additional PI polymers that can be used in the context of the present invention are described in U.S. Publication 2012/0276300, which is incorporated by reference. For instance, such PI polymers include both UV crosslinkable functional groups and pendent hydroxy functional groups: poly[3,3′,4,4′-benzophenonetetracarboxylic dianhydride-2,2-bis(3-amino-4-hydroxyphenyl)-hexafluoropropane] (poly(BTDA-APAF)), poly[4,4′-oxydiphthalic anhydride-2,2-bis(3-amino-4-hydroxyphenyl)-hexafluoropropane](poly(ODPA-APAF)), poly(3,3′,4,4′-benzophenonetetracarboxylic dianhydride-3,3′-dihydroxy-4,4′-diamino-biphenyl) (poly(BTDA-HA B)), poly[3,3′,4,4′-diphenylsulfone tetracarboxylic dianhydride-2,2-bis(3-amino-4-hydroxyphenyl)-hexafluoropropane] (poly(DSDA-APAF)), poly(3,3′,4,4′-diphenylsulfone tetracarboxylic dianhydride-2,2-bis(3-amino-4-hydroxyphenyl)-hexafluoropropane-3,3′-dihydroxy-4,4′-diamino-biphenyl) (poly(DSDA-APAF-HAB)), poly[2,2′-bis-(3,4-dicarboxyphenyl) hexafluoropropane dianhydride-3,3′,4,4′-benzophenonetetracarboxylic dianhydride-2,2-bis(3-amino-4-hydroxyphenyl)-hexafluoropropane] (poly(6FDA-BTDA-APAF)), poly[4,4′-oxydiphthalic anhydride-2,2-bis(3-amino-4-hydroxyphenyl)-hexafluoropropane-3,3′-dihydroxy-4,4′-diamino-biphenyl] (poly(ODPA-APAF-HAB)), poly[3,3′,4,4′-benzophenonetetracarboxylic dianhydride-2,2-bis(3-amino-4-hydroxyphenyl)-hexafluoropropane-3,3′-dihydroxy-4,4′-diamino-biphenyl] (poly(BTDA-APAF-HAB)), and poly(4,4′-bisphenol A dianhydride-3,3′,4,4′-benzophenonetetracarboxylic dianhydride-2,2-bis(3-amino-4-hydroxyphenyl)-hexafluoropropane] (poly(BPADA-BTDA-APAF)). More generically, the PI polymers can have the following formula (I):

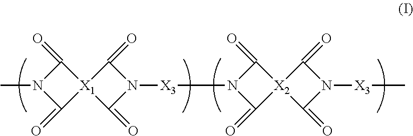

where the length of the polymer or “n” is typically greater than 1 or greater than 5 and typically from 10 to 10,000 or from 10 to 1000 or from 10 to 500, where —X₁— of said formula (I) is

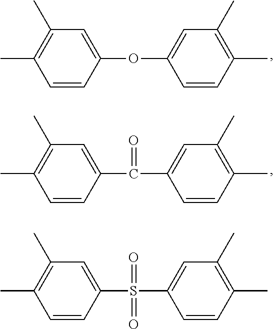

or mixtures thereof, —X₂— of said formula (I) is either the same as —X₁— or is selected from

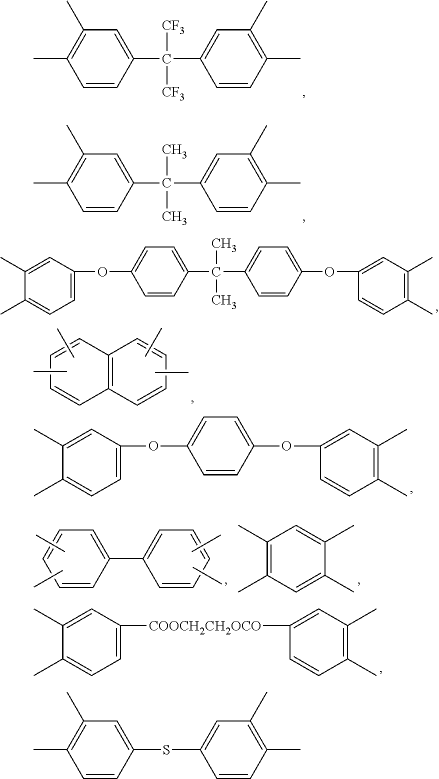

or mixtures thereof, —X₃— of said formula (I) is

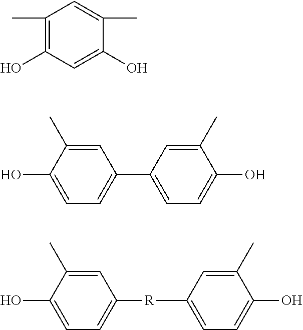

or mixtures thereof, —R— is

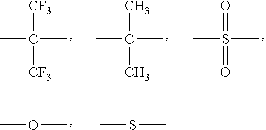

or mixtures thereof.

### B. Method of Making Membranes

There are many known methods for making polymeric membranes. Such methods that can be used include air casting (i.e., the dissolved polymer solution passes under a series of air flow ducts that control the evaporation of the solvents in a particular set period of time such as 24 to 48 hours), solvent or emersion casting, (i.e., the dissolved polymer is spread onto a moving belt and run through a bath or liquid in which the liquid within the bath exchanges with the solvent, thereby causing the formation of pores and the thus produced membrane is further dried), and thermal casting (i.e., heat is used to drive the solubility of the polymer in a given solvent system and the heated solution is then cast onto a moving belt and subjected to cooling).

A particular non-limiting process to make the blended polymeric membranes of the present invention is provided below:
(1) A PIM polymer and a second polymer are dissolved in an appropriate solvent (such as chloroform) and poured onto a glass plate.
(2) The poured material/glass plate is placed into a vacuum oven at mild temperature (around 70° C.) for up to 2 days to dry.
(3) Upon drying, the membrane thickness is measured (typically 60-100 um thick when dry).
(4) The dried membrane is then subjected to plasma treatment. In one non-limiting aspect, the plasma treatment can include subjecting at least a portion of the surface of the polymeric membrane to a plasma comprising a reactive species. The plasma can be generated by subjecting a reactive gas to a RF discharge with a RF power of 10 W to 700 W. The length of time the surface is subjected to the reactive species can be 30 seconds to 30 minutes at a temperature of 15° C. to 80° C. and at a pressure of 0.1 Torr to 0.5 Torr. A wide range of reactive gases can be used. In a particular aspect, the reactive gas can be a mixture of O₂ and CF₄ at a ratio of up to 1:2, where O₂ is provided at a flow rate of 0 to 40 cm³/min. and CF₄ is provided at a flow rate of 30 to 100 cm³/min.
(5) After plasma treatment, the polymeric membrane can be tested for single gas permeation for the different gases.

For permeation, testing is based on single gas measurement, in which the system is evacuated. The membrane is then purged with the desired gas three times. The membrane is tested following the purge for up to 8 hours. To test the second gas, the system is evacuated again and purged three times with this second gas. This process is repeated for any additional gasses. The permeation testing is set at a fixed temperature (20-50° C., preferably 25° C.) and pressure (preferably 2 atm). Additional treatments can be performed such as with chemicals, e-beam, gamma radiation, etc.

### C. Amounts of Polymers and Additives

The amount of polymer to add to the blend can be varied. For example, the amounts of each of the polymers in the blend can range from 5 to 95% by weight of the membrane. In particular aspects, each polymer can be present within the membrane in amounts from 1, 2, 3, 4, 5, 10, 15, 20, 25, 30, 35, 40, 45, 50, 55, 60, 65, 70, 75, 80, 85, or 95% by weight of the composition or membrane. Further, additives such covalent organic framework (COF) additives, metal-organic framework (MOF) additives, carbon nanotube (CNT) additives, fumed silica (FS), titanium dioxide (TiO₂), graphene, etc. can be added in amounts ranging from 1, 2, 3, 4, 5, 6, 7, 8, 9, 10, 15, 20, 25%, or more by weight of the membrane. Such additives can be added to the blend prior to formation of the membrane.

### D. Membrane Applications

The membranes of the present invention have a wide-range of commercial applications. For instance, and with respect to the petro-chemical and chemical industries, there are numerous petro-chemical/chemical processes that supply of pure or enriched gases such as He, N₂, and O₂, which use membranes to purify or enrich such gases. Further, removal, recapture, and reuse of gases such as CO₂ and H₂S from chemical process waste and from natural gas streams is of critical importance for complying with government regulations concerning the production of such gases as well as for environmental factors. Also, efficient separation of olefin and paraffin gases is key in the petrochemical industry. Such olefin/paraffin mixtures can originate from steam cracking units (e.g., ethylene production), catalytic cracking units (e.g., motor gasoline production), or dehydration of paraffins. Membranes of the present invention can be used in each of these as well as other applications. In particular instances, the membranes can be used to separate nitrogen from a mixture of gases that includes nitrogen and methane or hydrogen from a mixture of gases that includes hydrogen and methane or hydrogen from a mixture of gases that includes hydrogen from nitrogen.

For instance, the membranes of the present invention can be used in the purification, separation or adsorption of a particular species in the liquid or gas phase. In addition to separation of pairs of gases, the membranes can also be used to separate proteins or other thermally unstable compounds. The membranes may also be used in fermenters and bioreactors to transport gases into the reaction vessel and to transfer cell culture medium out of the vessel. Additionally, the membranes can be used to remove microorganisms from air or water streams, water purification, ethanol production in a continuous fermentation/membrane pervaporation system, and/or in detection or removal of trace compounds or metal salts in air or water streams.

In another instance, the membranes can be used in the separation of liquid mixtures by pervaporation, such as in the removal of organic compounds (e.g., alcohols, phenols, chlorinated hydrocarbons, pyridines, ketones) from water such as aqueous effluents or process fluids. By way of example, a membrane that is ethanol-selective could be used to increase the ethanol concentration in relatively dilute ethanol solutions (e.g., less than 10% ethanol or less than 5% ethanol or from 5 to 10% ethanol) obtained by fermentation processes. A further liquid phase separation example that is contemplated with the compositions and membranes of the present invention includes the deep desulfurization of gasoline and diesel fuels by a pervaporation membrane process (see, e.g., U.S. Pat. No. 7,048,846, which is incorporated by reference). Compositions and membranes of the present invention that are selective to sulfur-containing molecules could be used to selectively remove sulfur-containing molecules from fluid catalytic cracking (FCC) and other naphtha hydrocarbon streams. Further, mixtures of organic compounds that can be separated with the compositions and membranes of the present invention include ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and/or ethylacetate-ethanol-acetic acid.

In particular instances, the membranes of the present invention can be used in gas separation processes in air purification, petrochemical, refinery, natural gas industries. Examples of such separations include separation of volatile organic compounds (such as toluene, xylene, and acetone) from chemical process waste streams and from Flue gas streams. Further examples of such separations include the separation of CO₂ from natural gas, H₂ from N₂, CH₄, and Ar in ammonia purge gas streams, H₂ recovery in refineries, olefin/paraffin separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the blended polymeric membranes described herein. More than two gases can be removed from a third gas. For example, some of the gas components which can be selectively removed from a raw natural gas using the membranes described herein include carbon dioxide, oxygen, nitrogen, water vapor, hydrogen sulfide, helium, and other trace gases. Some of the gas components that can be selectively retained include hydrocarbon gases. In further instances, the membranes can be used on a mixture of gases that include at least 2, 3, 4, or more gases such that a selected gas or gases pass through the membrane (e.g., permeated gas or a mixture of permeated gases) while the remaining gas or gases do not pass through the membrane (e.g., retained gas or a mixture of retained gases).

Additionally, the membranes of the present invention can be used to separate organic molecules from water (e.g., ethanol and/or phenol from water by pervaporation) and removal of metal (e.g., mercury(II) ion and radioactive cesium(I) ion) and other organic compounds (e.g., benzene and atrazene from water).

A further use of the membranes of the present invention include their use in chemical reactors to enhance the yield of equilibrium-limited reactions by selective removal of a specific product in an analogous fashion to the use of hydrophilic membranes to enhance esterification yield by the removal of water.

The membranes of the present invention can also be fabricated into any convenient form such as sheets, tubes, spiral, or hollow fibers. They can also be fabricated into thin film composite membranes incorporating a selective thin layer that has been plasma-treated and a porous supporting layer comprising a different polymer material.

Table 1 includes some particular non-limiting gas separation applications of the present invention.

TABLE 1

| Gas Separation | Application |
|---|---|
| O₂/N₂ | Nitrogen generation, oxygen enrichment |
| H₂/hydrocarbons | Refinery hydrocarbon recovery |
| H₂/CO | Syngas ratio adjustment |
| H₂/N₂ | Ammonia purge gas |
| CO₂/hydrocarbon | Acid gas treating, enhanced oil recovery, |
| | landfill gas upgrading, pollution control |
| H₂S/hydrocarbon | Sour gas treating |
| H₂O/hydrocarbon | Natural gas dehydration |
| H₂O/air | Air dehydration |
| Hydrocarbons/air | Pollution control, hydrocarbon recovery |
| Hydrocarbons from | Organic solvent recovery, monomer recovery |
| process streams | |
| Olefin/paraffin | Refinery |

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Synthesis of PIM-1

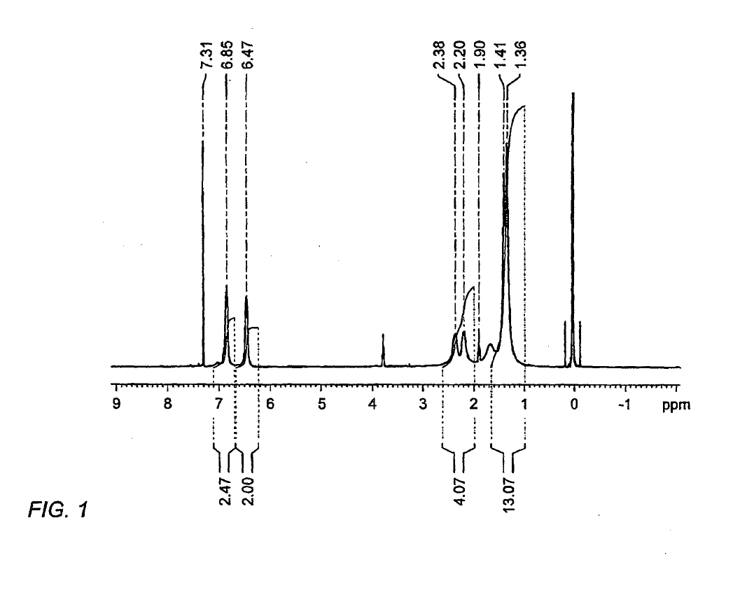

3,3,3′,3′,-tetramethyl-spirobisindan-5,5′6,6′-tetraol (340 mg, 1.00 mmol) and 1,4-dicyanotetrafluorobenzene (200 mg, 1.00 mmol) were dissolved in anhydrous DMAc (2.7 mL), which was stirred at room temperature (i.e., about 20 to 25° C.) for 15 minutes for the totally dissolve of the reagents. Grand K₂CO₃ (390 mg, 2.5 mmol) was added in one portion, the reaction system was stirred at room temperature for another half an hour before being heated to 150° C. The viscosity increased in the first 10 minutes, toluene (3.0 ml) was added in one portion, and the system was stirred at 150° C. for another 10 minutes. The resulting mixture was poured into methanol/water=1/1 solvent, the precipitate was filtered and washed with boiling water three (3) times, and then dissolved in chloroform and precipitated in methanol. A yellow powder (450 mg, 97.8% yield) was obtained after vacuum drying at 120° C. for 12 hours. Mn 100,000, Mw 200,000, PDI=2.0. Characterization: 1H NMR (400 MHz, CDCl₃) 6.85 (s, 2H), 6.48 (s, 2H), 2.30 (s, 2H), 2.20 (s, 2H), 1.39 (d, 12H, J=22.8 Hz) (see FIG. 1).

### Example 2

### Membrane Preparation

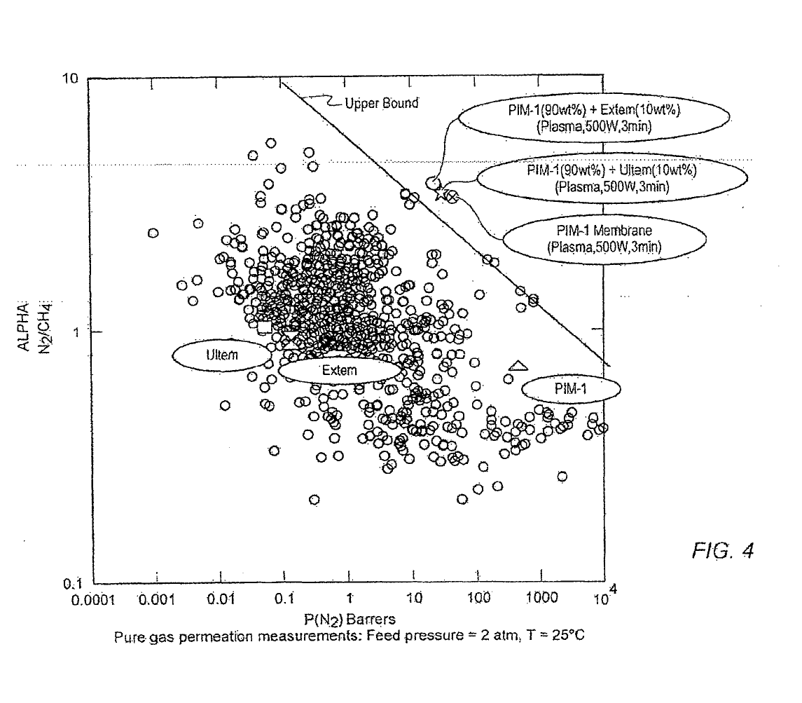

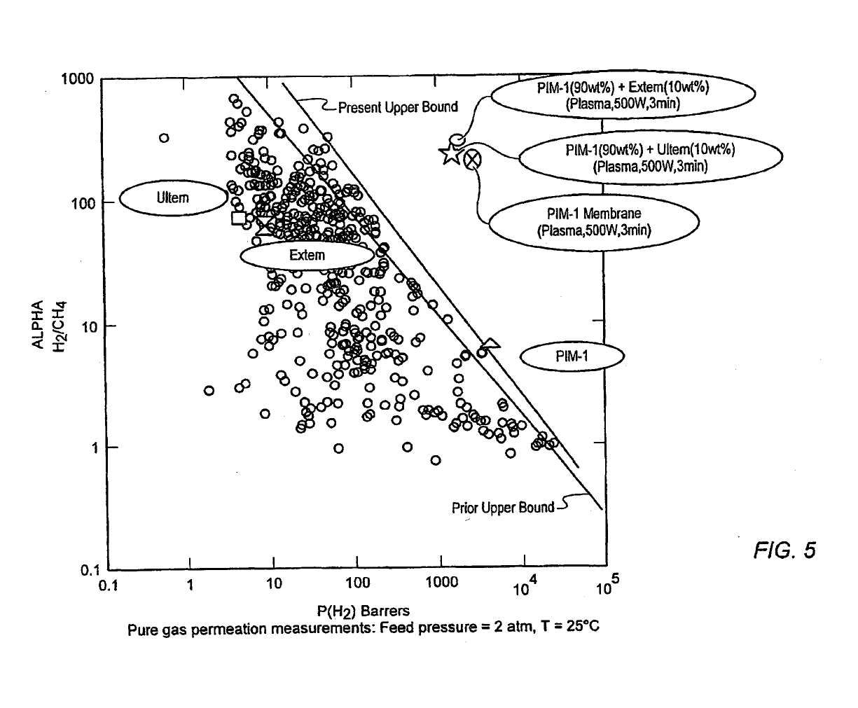

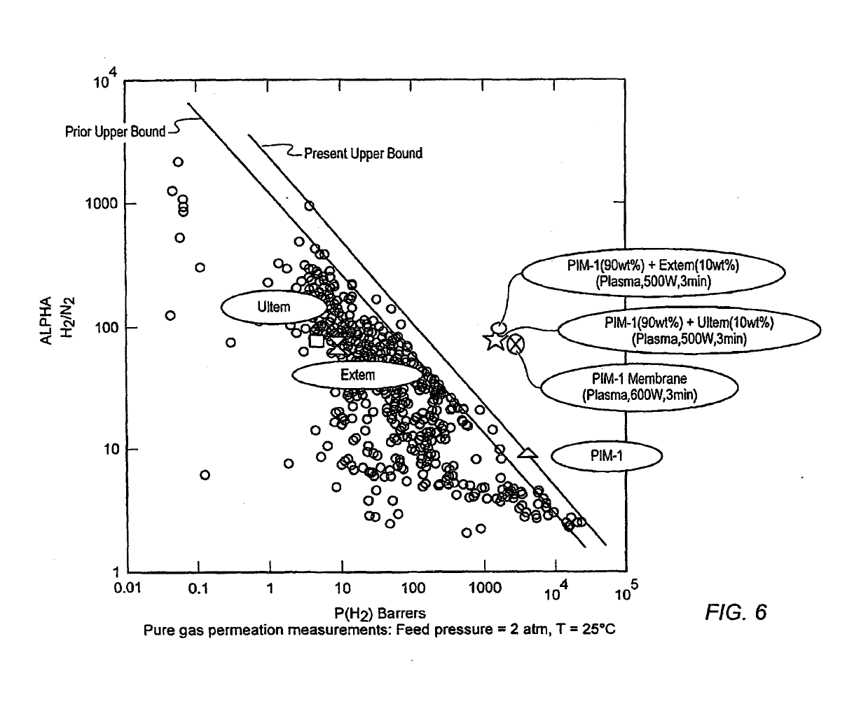

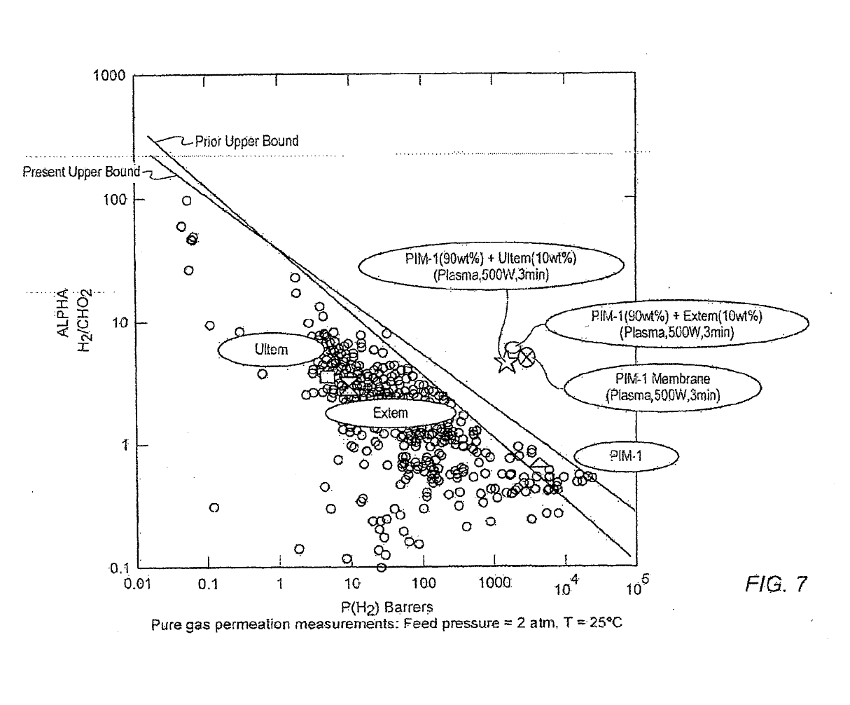

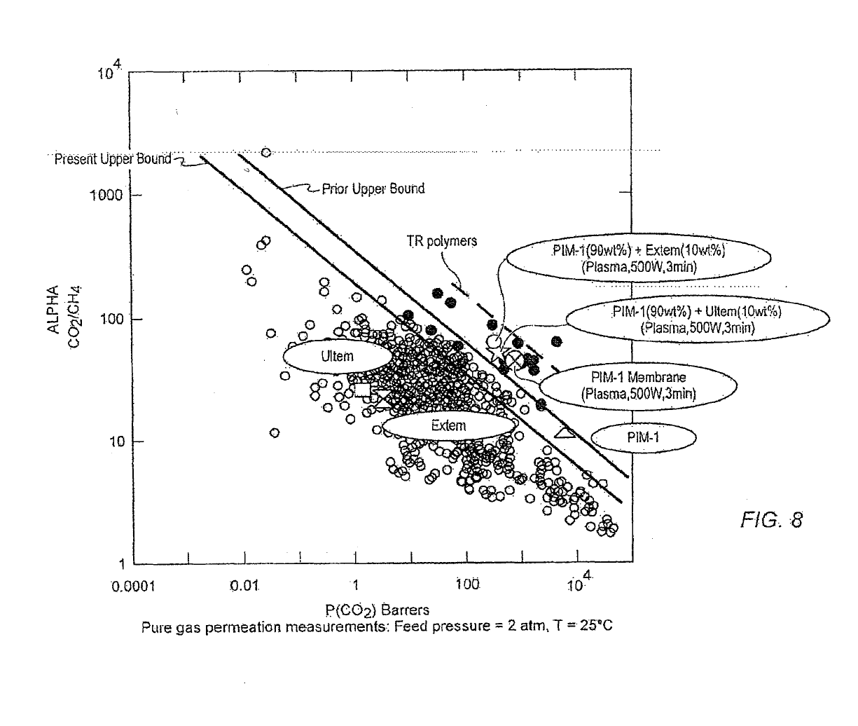

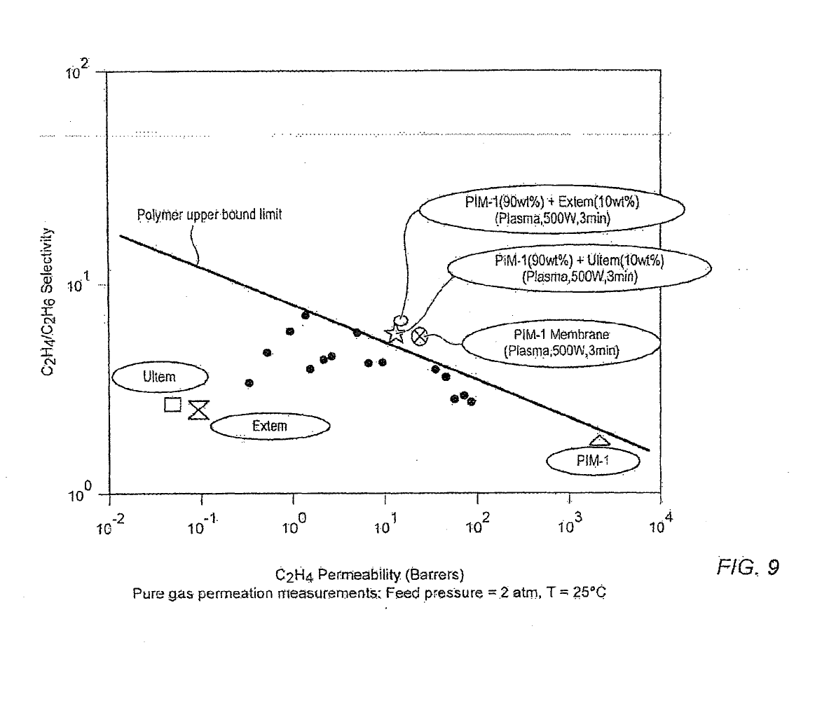

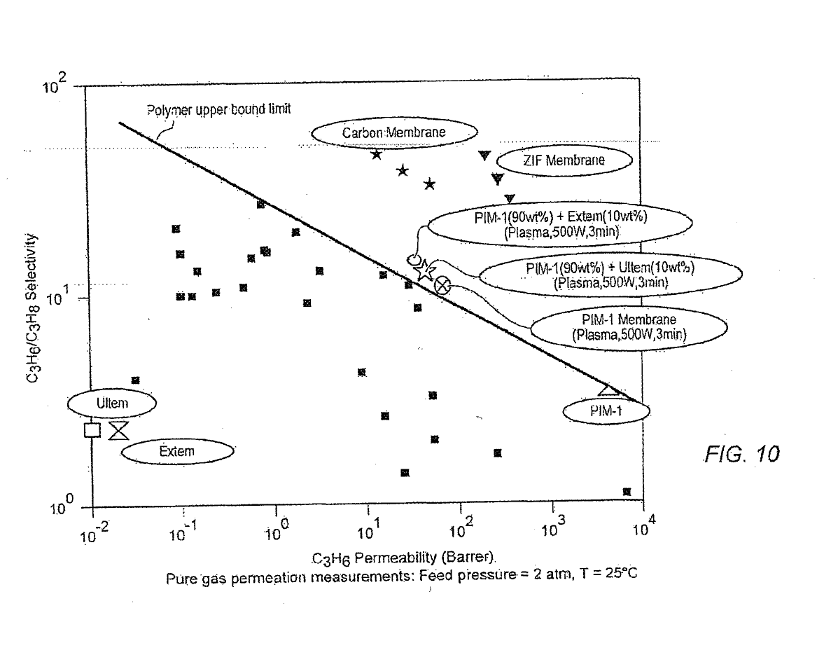

A PIM-1, an Extem®, an Ultem®, three PIM-1/Ultem and one PIM-1/Extem dense membranes were prepared by a solution casting method. For the PIM-1/Ultem and PIM-1/Extem blended membranes, both Ultem and Extem are commercially available from SABIC Innovative Plastics Holding BV. The Ultem and Extem are each dissolved in CH₂Cl₂ and stirred for 4 hours. Subsequently, PIM-1 from Example 1 was added to each solution of Ultem and Extem and stirred overnight. Each of the membranes were each prepared with a total 2 wt % polymer concentration in CH₂Cl₂. For the PIM-1/Ultem and PIM-1/Extem membranes, the blend ratio was 90:10 wt % for each blended membrane (see Table 2 below and FIGS. 4-10). The solutions were then filtered by 1 μm PTFE filter and transferred into a stainless steel ring supported by a leveled glass plate at Room temperature (i.e., about 20 to 25° C.). The polymer membranes were formed after most of the solvent had evaporated after 3 days. The resultant membranes were dried at 80° C. under vacuum for at least 24 hours. The membrane thickness was measured by an electronic Mitutoyo 2109F thickness gauge (Mitutoyo Corp., Kanagawa, Japan). The gauge was a non-destructive drop-down type with a resolution of 1 micron. Membranes were scanned at a scaling of 100% (uncompressed tiff-format) and analyzed by Scion Image (Scion Corp., MD, USA) software. The effective area was sketched with the draw-by-hand tool both clockwise and counter-clockwise several times. The thickness recorded is an average value obtained from 8 different points of the membranes. The thicknesses of the casted membranes were about 77±5 μm.

Plasma treatment of all of the produced membranes was based on plasma generated by a radio-frequency (RF) discharge using a Nanoplas (DSB 6000) machine. The particular parameters of the plasma treatment process are provided in Table 2 below (i.e., plasma power of 400 W, 500 W, and 600 W; treatment time of 3 min.; reactive gas mixture of O₂/CF₄ at a ratio of 15:40 and flow rate of 65 cm³/min; pressure of 0.4 Torr).

### Example 3

### Masking of Membranes

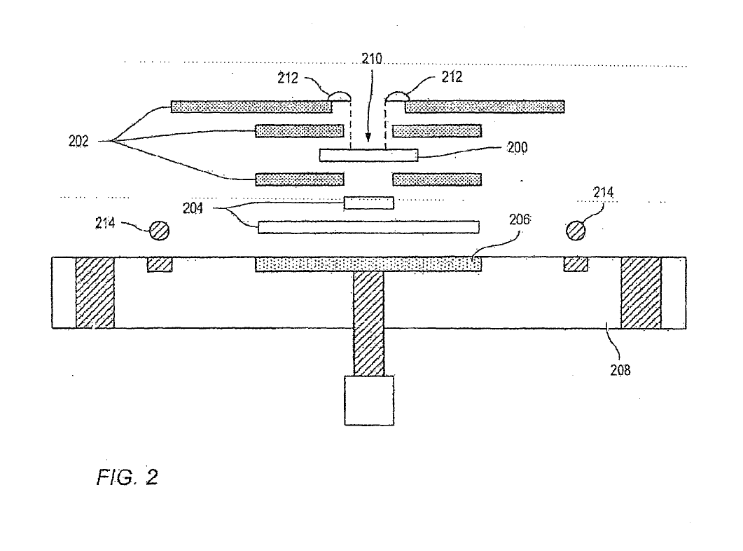

The membranes 200 were masked using impermeable aluminum tape 202 (3M 7940, see FIG. 2). Filter paper (Schleicher & Schuell BioScience GmbH, Germany) 204 was placed between the metal sinter (Tridelta Siperm GmbH, Germany) 206 of the permeation cell 208 and the masked membrane 200 to protect the membrane mechanically. A smaller piece of filter paper 204 was placed below the effective permeation area 210 of the membrane, offsetting the difference in height and providing support for the membrane. A wider tape 202 was put on top of the membrane/tape sandwich to prevent gas leaks from feed side to permeate side. Epoxy (Devcon®, 2-component 5-Minute Epoxy) 212 was applied at the interface of the tape and membrane also to prevent leaks. [An] O-rings 214 sealed the membrane module from the external environment. No inner O-ring (upper cell flange) was used.

### Example 4

### Permeability and Selectivity Data

The gas transport properties were measured using the variable pressure (constant volume) method. Ultrahigh-purity gases (99.99%) were used for all experiments. The membrane was mounted in a permeation cell prior to degassing the whole apparatus. Permeant gas was then introduced on the upstream side, and the permeant pressure on the downstream side was monitored using a pressure transducer. From the known steady-state permeation rate, pressure difference across the membrane, permeable area and film thickness, the permeability coefficient was determined (pure gas tests). The permeability coefficient, P [cm³ (STP)·cm/cm²·s·cmHg], is determined by the following equation:

$$P = \frac{1}{760} \times \frac{V}{A} \times \frac{273}{273 + T} \times \frac{L}{760 p} \times \frac{d p}{d t}$$

where A is the membrane area (cm),

L Is the membrane thickness (cm),

p is the differential pressure between the upstream and the downstream (MPa),

V is the downstream volume (cm³),

R is the universal gas constant (6236.56 cm³·cmHg/mol·K),

T is the cell temperature (C), and

dp/dt is the permeation rate.

The as permeabilities of polymer membranes are characterized by a mean permeability coefficient with units of Barrer. 1 Barrer=10⁻¹⁰ cm³ (STP)·cm/cm²·s·cmHg. The gas permeability coefficient can be explained on the basis of the solution-diffusion mechanism, which is represented by the following equation:

P=D×S

where D (cm²/s) is the diffusion coefficient; and

S (cm³ (STP)/cm³·cmHg) is the solubility coefficient.

The diffusion coefficient was calculated by the time-lag method, represented by the following equation:

$$D = \frac{{L}^{2}}{6 θ}$$

where θ(s) is the time-lag. Once P and D were calculated, the apparent solubility coefficient S (cm³(STP)/cm³·cmHg) may be calculated by the following expression:

$$S = \frac{P}{D}$$

The ideal selectivity of a dense membrane for gas A to gas B is defined as follows:

$$α = \frac{{P}_{A}}{{P}_{B}} = \frac{{D}_{A}}{{D}_{B}} * \frac{{S}_{A}}{{S}_{B}}$$

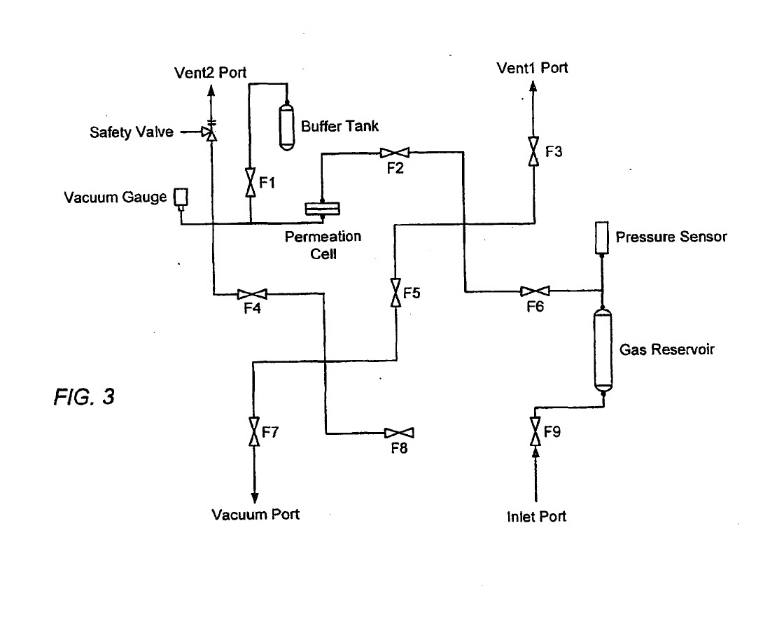

FIG. 3 provides the flow scheme of the permeability apparatus used in procuring the permeability and selectivity data.

The permeability and selectivity data procured from various membranes using the above techniques is provided in Table 2. FIGS. 4-10 provide several data points confirming that the plasma-treated membranes of the present invention exhibit gas separation performances for various gas mixtures above the polymer upper bound limit. Prior literature polymeric membrane permeation data have failed to surpass the upper boundary line (dots below upper boundary lines).

TABLE 2
(Permeability Data and Ideal Selectivity)

| | Conditions | | | | | | | | | | | | |
|---|---|---|---|---|---|---|---|---|---|---|---|---|---|
| | Power | Time | T | P | Thickness | Permeability (Barrer) | | | | | | | |
| Sample | (W) | (min) | (° C.) | (atm) | (μm) | N₂ | H₂ | CH₄ | CO₂ | C₂H₄ | C₂H₆ | C₃H₆ | C₃H₈ |
| Ultem | No Plasma | | 25 | 2 | 79 | 0.062 | 4.6 | 0.059 | 1.45 | 0.05 | 0.017 | 0.009 | 0.004 |
| Extem | No Plasma | | 25 | 2 | 77 | 0.13 | 9.5 | 0.15 | 3.21 | 0.086 | 0.034 | 0.018 | 0.008 |
| PIM-1 | No Plasma | | 25 | 2 | 80 | 435 | 4087 | 583 | 6090 | 2003 | 1202 | 4290 | 1281 |
| Ultem | 500 | 3 | 25 | 2 | 81 | 0.058 | 4.5 | 0.015 | 1.38 | — | — | — | — |
| Extem | 500 | 3 | 25 | 2 | 82 | 0.11 | 9.3 | 0.03 | 3.02 | — | — | — | — |
| PIM-1 | 500 | 3 | 25 | 2 | 83 | 41.3 | 2927 | 12.8 | 587 | 23.0 | 4.0 | 64.3 | 6.2 |
| PIM-1 | 400 | 3 | 25 | 2 | 81 | 25.4 | 1780 | 8.3 | 369 | 18.2 | 3.6 | 57.8 | 5.9 |
| (90 wt %)- | | | | | | | | | | | | | |
| Ultem | | | | | | | | | | | | | |
| (10 wt %) | | | | | | | | | | | | | |
| PIM-1 | 500 | 3 | 25 | 2 | 82 | 23.2 | 1671 | 6.9 | 344 | 12.8 | 2.2 | 41.5 | 3.5 |
| (90 wt %)- | | | | | | | | | | | | | |
| Ultem | | | | | | | | | | | | | |
| (10 wt %) | | | | | | | | | | | | | |
| PIM-1 | 600 | 3 | 25 | 2 | 80 | 14.7 | 1480 | 4.1 | 293 | 4.0 | 0.38 | 8.9 | 1.1 |
| (90 wt %)- | | | | | | | | | | | | | |
| Ultem | | | | | | | | | | | | | |
| (10 wt %) | | | | | | | | | | | | | |
| PIM-1 | 500 | 3 | 25 | 2 | 81 | 21.7 | 1798 | 6.0 | 332 | 15.3 | 2.4 | 38.9 | 3.1 |
| (90 wt %)- | | | | | | | | | | | | | |
| Extem | | | | | | | | | | | | | |
| (10 wt %) | | | | | | | | | | | | | |

| | Ideal Selectivity | | | | | | | | | | | |
|---|---|---|---|---|---|---|---|---|---|---|---|---|
| | H₂/ | H₂/ | N₂/ | CO₂/ | CO₂/ | H₂/ | CO₂/ | C₂H₄/ | C₃H₆/ | CO₂/ | H₂/ | H₂/ |
| | N₂ | CO₂ | CH₄ | N₂ | CH₄ | CH₄ | C₂H₄ | C₂H₆ | C₃H₈ | C₂H₆ | C₂H₄ | C₃H₆ |
| Ultem | 74.2 | 3.2 | 1.1 | 23.4 | 24.6 | 78.0 | 32.2 | 2.6 | 2.3 | 85.3 | 102.2 | 511.1 |
| Extem | 73.1 | 3.0 | 0.9 | 24.7 | 21.4 | 63.3 | 37.3 | 2.5 | 2.3 | 94.4 | 110.5 | 527.8 |
| PIM-1 | 9.4 | 0.7 | 0.7 | 14.0 | 10.4 | 7.0 | 3.0 | 1.7 | 3.3 | 5.1 | 2.0 | 1.0 |
| Ultem | 77.6 | 3.3 | 3.9 | 23.8 | 92.0 | 300.0 | — | — | — | — | — | — |
| Extem | 84.5 | 3.1 | 3.7 | 27.5 | 100.7 | 310.0 | — | — | — | — | — | — |
| PIM-1 | 70.9 | 5.0 | 3.2 | 14.2 | 45.9 | 228.7 | 25.5 | 5.7 | 10.4 | 145.0 | 127.2 | 45.5 |
| PIM-1 | 70.2 | 4.8 | 3.1 | 14.6 | 44.6 | 215.0 | 20.3 | 5.1 | 9.8 | 102.5 | 97.8 | 30.8 |
| (90 wt %)- | | | | | | | | | | | | |
| Ultem | | | | | | | | | | | | |
| (10 wt %) | | | | | | | | | | | | |
| PIM-1 | 72.0 | 4.9 | 3.4 | 14.8 | 49.9 | 242.2 | 26.9 | 5.8 | 11.9 | 156.4 | 130.5 | 40.3 |
| (90 wt %)- | | | | | | | | | | | | |
| Ultem | | | | | | | | | | | | |
| (10 wt %) | | | | | | | | | | | | |
| PIM-1 | 100.7 | 5.1 | 3.6 | 19.9 | 71.5 | 361.0 | 73.3 | 10.5 | 8.1 | 771.1 | 370.0 | 166.3 |
| (90 wt %)- | | | | | | | | | | | | |
| Ultem | | | | | | | | | | | | |
| (10 wt %) | | | | | | | | | | | | |
| PIM-1 | 32.9 | 5.4 | 3.6 | 15.3 | 55.3 | 299.7 | 21.7 | 6.4 | 12.5 | 138.3 | 117.5 | 46.2 |
| (90 wt %)- | | | | | | | | | | | | |
| Extem | | | | | | | | | | | | |
| (10 wt %) | | | | | | | | | | | | |

1. A polymeric membrane comprising a polymeric blend that includes a polymer of intrinsic microporosity (PIM) and a second polymer, wherein the polymeric membrane has been plasma-treated.

2. The polymeric membrane of claim 1, wherein the PIM polymer is PIM-1.

3. The polymeric membrane of claim 1, wherein the second polymer is a polyetherimide (PEI) polymer, a polyimide (PI) polymer, a polyetherimide-siloxane (PEI-Si) polymer, or a second PIM polymer that is different than the PIM polymer of claim 1.

4. The polymeric membrane of claim 3, wherein the second polymer is a PEI polymer.

5. The polymeric membrane of claim 1, wherein the membrane is capable of separating a first gas from a second gas or is capable of separating a first gas from a mixture of gases.

6. The polymeric membrane of claim 5, wherein the first gas is nitrogen and the second gas is methane, or wherein the first gas is hydrogen and the second gas is methane, or wherein the first gas is hydrogen and the second gas is nitrogen.

7. The polymeric membrane of claim 5, wherein the first gas is nitrogen and the mixture of gases includes nitrogen and methane, or wherein the first gas is hydrogen and the mixture of gases includes hydrogen and nitrogen, or wherein the first gas is hydrogen and the mixture of gases includes hydrogen and methane.

8. The polymeric membrane of claim 6, wherein the polymeric membrane has a selectivity of nitrogen to methane or hydrogen to nitrogen or hydrogen to methane that exceeds the Robeson's upper bound trade-off curve at a temperature of 25° C. and a feed pressure of 2 atm.

9. The polymeric membrane of claim 2, wherein the membrane comprises from 80 to 95% w/w of PIM-1 and from 5 to 20% w/w of the PEI polymer.

10. The polymeric membrane of claim 1, wherein the membrane was plasma-treated with a plasma gas comprising a reactive species for 30 seconds to 30 minutes, 30 second to 10 minutes, 1 to 5 minutes, or 2 to 4 minutes.

11. The polymeric membrane of claim 10, wherein the membrane was plasma-treated at a temperature of 15° C. to 80° C. or about 50° C.

12-13. (canceled)

14. The polymeric membrane of claim 1, wherein the membrane is a flat sheet membrane, a spiral membrane, a tubular membrane, or a hollow fiber membrane.

15. The polymeric membrane of claim 1, wherein the membrane comprises from 5 to 95% by weight of the PIM polymer and from 95 to 5% by weight of the second polymer.

16. The polymeric membrane of claim 1, wherein the blend comprises at least two or at least three different polymers.

17. The polymeric membrane of claim 1, where the membrane further comprises a covalent organic framework (COF) additive, a carbon nanotube (CNT) additive, fumed silica (FS), titanium dioxide (TiO₂) or graphene.

18. The polymeric membrane of claim 1, wherein the PIM polymer has repeating units of formula:

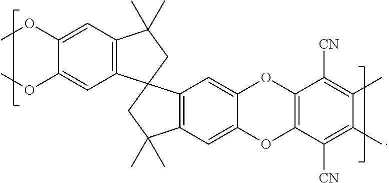

19. (canceled)

20. A method for separating at least one component from a mixture of components, the method comprising: contacting a mixture of components on a first side of any one of the polymeric membranes of claim 1, such that at least a first component is retained on the first side in the form of a retentate and at least a second component is permeated through the membrane to a second side in the form of a permeate.

21. The method of claim 20, wherein the first component is a first gas and the second component is a second gas, and wherein the first gas is nitrogen and the second gas is methane, or wherein the first gas is hydrogen and the second gas is methane, or wherein the first gas is hydrogen and the second gas is nitrogen.

22. (canceled)

23. (canceled)

24. The method of claim 20, wherein the pressure at which the mixture is fed to the membrane is from 2 to 20 atm at a temperature ranging from 20 to 65° C.

25-44. (canceled)

45. A gas separation device comprising any one of the polymeric membranes of claim 1.

46-48. (canceled)
